(19) United States
(12) Patent Application Publication
(10) Pub. No.: US 2020/0156274 A1
(43) Pub. Date: May 21, 2020

(54) RAZOR HANDLE

(71) Applicant: Bic Violex S.A., Anixi (GR)

(72) Inventors: Georgios GEORGAKIS, Athens (GR); Nikolaos OVVADIAS, Athens (GR); Ioannis Marios PSIMADAS, Athens (GR)

(73) Assignee: Bic Violex S.A., Anixi (GR)

(21) Appl. No.: 16/610,770

(22) PCT Filed: May 4, 2018
(86) PCT No.: PCT/EP2018/061496

§ 371 Date: Nov. 4, 2019

(30) Foreign Application Priority Data
May 5, 2017 (EP) 17169741.0

(51) Int. Cl. B26B 21/52; B26B 21/22

(52) U.S. Cl. CPC B26B 21/521; B26B 21/522; B26B 21/225

(57) ABSTRACT

A razor handle and a method for releasing an exchangeable razor blade cartridge from the razor handle. The razor handle including a connector for connecting the exchangeable razor blade cartridge to the razor handle, a release mechanism for releasing the exchangeable razor blade cartridge from the razor handle, and a release trigger. The release trigger is rotatable around a longitudinal axis of the razor handle relative to the connector to actuate the release mechanism.

### CROSS REFERENCE TO RELATED APPLICATIONS

This application is a National Stage application of International Application No. PCT/EP2018/061496, filed on May 4, 2018, now published as WO/2018/202848 and which claims priority to European Application No. 17169741.0, filed May 5, 2017.

### FIELD

The present disclosure relates to razors, and more specifically to razors of the type comprising a razor handle and an exchangeable razor blade cartridge. The razors, which may be specifically adapted for shaving facial, head and/or body hair, may allow for replacement of the exchangeable razor blade cartridge. Replacement of the exchangeable razor blade cartridge may occur particularly when a razor blade or blades of the razor blade cartridge have been blunted and may be facilitated without discarding the razor handle.

### BACKGROUND

Razors comprising a razor handle and an exchangeable razor blade cartridge are commonly known in the art. In such razors, the razor handle may comprise an elongated body extending in a longitudinal direction from a front end to a rear end, a connector for connecting an exchangeable razor blade cartridge to the razor handle, and a release mechanism for releasing the exchangeable razor blade cartridge from the razor handle, and a release trigger, located at the front end of the razor handle, in close proximity to the release mechanism and connector, to trigger the release of the exchangeable razor blade cartridge from the connector.

A drawback of this configuration is that, because the release trigger is located near the front end of the razor handle, release of the exchangeable razor cartridge may be inadvertently triggered by a user moving his grip closer to the front end of the razor handle when trying to achieve a more precise shave.

### SUMMARY

A first aspect of the disclosure concerns providing a more convenient and safer razor handle and in particular a razor handle having an elongated body, a connector for connecting an exchangeable razor blade cartridge to the razor handle, a release mechanism for releasing the exchangeable razor blade cartridge from the razor handle, and a release trigger, wherein the risk of inadvertent release of an exchangeable razor blade cartridge may be decreased.

Accordingly, in at least one aspect, the release trigger may be rotatable around a longitudinal axis of the razor handle relative to the connector to actuate the release mechanism.

The release trigger may comprise a rear part of the razor handle and the connector may be located at a front end of the razor handle. By allowing the rear part of the razor handle to comprise the release trigger and by locating the connector at the front end of the razor handle, inadvertent operation of the release trigger may be prevented when the user holds the razor handle close to the connector. Thus, positioning the release trigger apart from the connector, may decrease the overall risk of inadvertent operation of the release mechanism.

The razor handle may further comprise a cam mechanism for converting a rotation of the release trigger about the longitudinal axis, relative to the connector, into a motion along the longitudinal axis to actuate the release mechanism. Operation of the release trigger may be facilitated by this cam mechanism. In particular, the cam mechanism may comprise first and second cam surfaces that may be inclined in opposite directions. Inclining the cam surfaces in opposing directions facilitates the conversion of opposite rotational movements of the release trigger into longitudinal movement in the same direction for actuation of the release mechanism. Consequently, release of the exchangeable razor blade cartridge may be triggered by turning the release trigger in either direction about the longitudinal axis, relative to the connector, from a central starting position. However, the conversion of a rotation of the release trigger around the longitudinal axis into a motion along the longitudinal axis may also be carried out by other means than a cam mechanism, such as, for example, magnetic mechanism.

The razor handle may be simply and reliably connected to the exchangeable razor blade cartridge by a snap-fit connection in which a latching surface of the exchangeable blade cartridge engages an opposite surface of the connector to retain the exchangeable razor blade cartridge relative to the connector. The release mechanism may be configured to deflect the latching surface of the exchangeable blade cartridge out of engagement with the connector, so as to release the snap-fit connection between the razor handle and the exchangeable razor blade cartridge.

The razor handle may further comprise a spring-loaded pusher for urging a pivotable head of the exchangeable razor blade cartridge in one pivoting direction. The spring-loaded pusher may provide for closer contact and better alignment of the razor blades with the skin during shaving. The release mechanism may then be formed as a fork-shaped ejector comprising two front prongs, and the spring-loaded pusher be located between the two front prongs. This structure may allow for a more compact arrangement. Alternatively, however, the release mechanism may be analogous to those disclosed in international patent application publications WO 2016/087007, WO2015/158382 and WO2010/037418.

A second aspect of the disclosure concerns a razor comprising a razor handle and an exchangeable razor blade cartridge connected by the connector to the razor handle.

The exchangeable razor blade cartridge may comprise an interconnecting member configured to engage the connector, and a pivotable head. The interconnecting member may facilitate engagement of the exchangeable razor blade cartridge with the connector. The pivotable head may comprise at least one razor blade and may be supported so as to be pivotable around at least one transverse axis with respect to the interconnecting member. The exchangeable razor blade cartridge and pivotable head may provide for a closer contact and better alignment of the razor blades with the skin during shaving. The exchangeable razor blade cartridge may be snap-fitted to the connector. The snap-fit connection may ensure a reliable and simple connection of the razor handle to the exchangeable razor blade cartridge. The pivotable head may provide closer contact and better alignment of the razor blades with the skin during shaving.

A third aspect concerns a method for releasing an exchangeable razor blade cartridge from a razor handle. This method may comprise a step of rotating a release trigger about a longitudinal axis of the razor handle, relative to a connector which connects the exchangeable razor blade cartridge to the razor handle, to actuate a release mechanism so as to release the exchangeable razor blade cartridge from the connector.

The above summary is not intended to describe each aspect or every implementation of the disclosed concept. In particular, selected features of illustrative embodiments within this disclosure may easily be incorporated into additional embodiments unless clearly stated to the contrary.

### BRIEF DESCRIPTION OF THE DRAWINGS

The disclosure may be more completely understood in consideration of the following detailed description of various aspects of the disclosure in connection with the accompanying drawings, in which:

FIG. 1 is a first perspective view of a razor according to an aspect of the disclosure;

FIG. 2 is a second perspective view of the razor of FIG. 1;

FIG. 3 is a perspective exploded view of the razor of FIG. 1;

FIG. 4 is a longitudinal cut view of the razor of FIG. 1 along plane IV-IV;

FIG. 5 illustrates the snap-fit connection of the razor handle and exchangeable razor blade;

FIG. 6 is a detail cut view of the exchangeable razor blade cartridge and the connector of the blade handle once connected;

FIG. 7A is a detail view of the release mechanism at a first position before release of the exchangeable razor blade cartridge from the razor handle;

FIGS. 7B and 7C are detail views of the release mechanism at second and third positions when releasing the exchangeable razor blade cartridge from the razor handle by turning the release trigger in each direction around a longitudinal axis;

FIGS. 8A and 8B schematically illustrate alternative magnetic and press-fit connections;

FIG. 9 is a schematic drawing of an alternative return mechanism for the razor of FIG. 1; and

FIGS. 10A and 10B are schematic views of a razor according to another aspect of the disclosure, with the release trigger in two different positions.

While the disclosure is amenable to various modifications and alternative forms, specifics thereof have been shown by way of example in the drawings and will be described in detail. It should be understood, however, that the intention is not to limit aspects of the disclosure to the particular embodiments described. On the contrary, the intention is to cover all modifications, equivalents, and alternatives falling within the scope of the disclosure.

### DETAILED DESCRIPTION

As used in this disclosure and the appended claims, the singular forms “a”, “an”, and “the” include plural referents unless the content clearly dictates otherwise. As used in this disclosure and the appended claims, the term “or” is generally employed in its sense including “and/or” unless the content clearly dictates otherwise.

The following detailed description should be read with reference to the drawings. The detailed description and the drawings, which are not necessarily to scale, depict illustrative aspects of the disclosure and are not intended to limit the scope. The illustrative aspects depicted are intended only as exemplary.

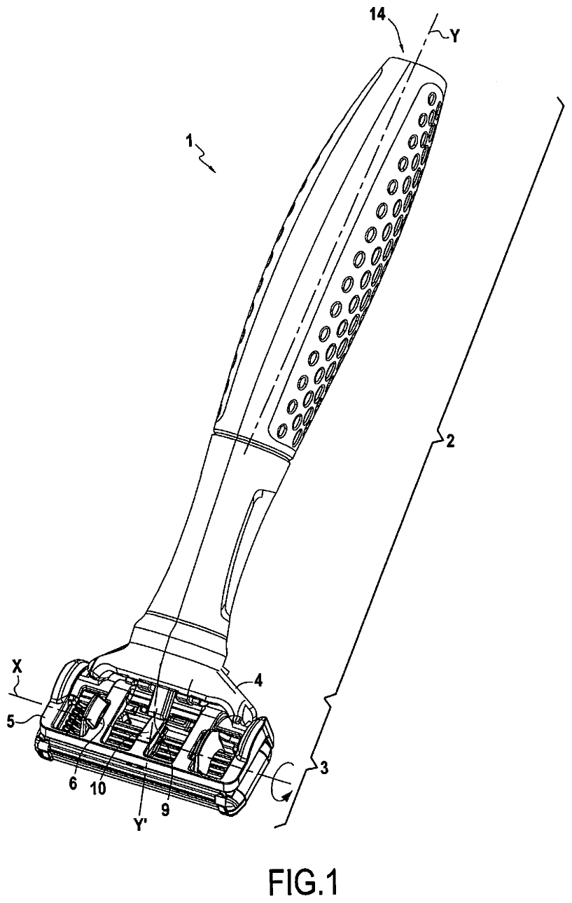

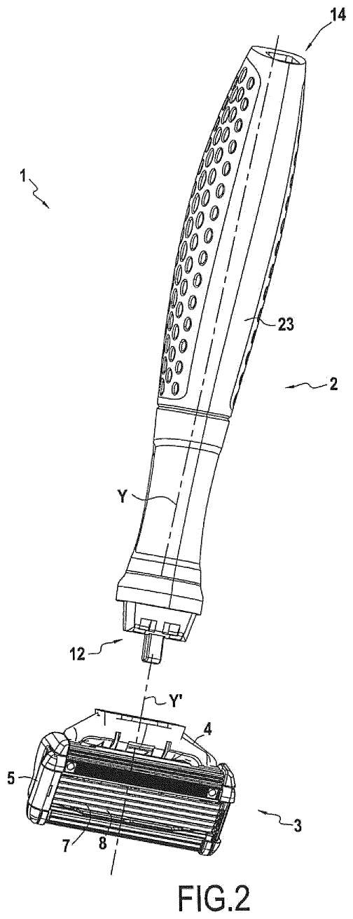

A razor 1 according to an aspect is shown in FIGS. 1 to 4. This razor 1 may be a wet-shave razor. The razor 1 may comprise a razor handle 2 and an exchangeable razor blade cartridge 3. The exchangeable razor blade cartridge 3 may comprise an interconnecting member 4 and a pivotable head 5 connected to the interconnecting member 4. As provided in further detail below, the interconnecting member 4 is configured to facilitate connection of the exchangeable razor blade cartridge 3 with the razor handle 2. The interconnecting member 4 may comprise arcuate tracks 6 configured to support razor blades 8. The pivotable head 5 may be a multi-blade head, for example, a five-blade head. Alternatively, however, it may comprise one single razor blade. The pivotable head 5 may be supported by the arcuate tracks 6 of the interconnecting member 4 so as to be pivotable, relative to the interconnecting member 4, about at least one transverse axis X which is substantially parallel to the cutting edges 7 of razor blades 8 mounted on the pivotable head 5.

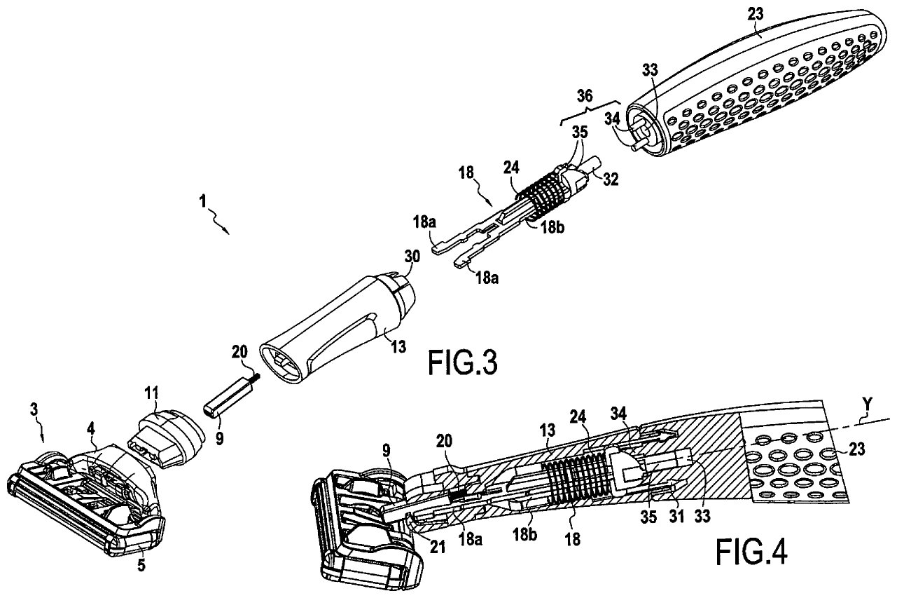

According to further aspects, the razor handle 2 may be elongated and extend along longitudinal axis Y from a front end 12 to a rear end 14. As shown on FIG. 3, the razor handle 2 may comprise a connector 11, located at the front end 12 of the razor handle 2, a central body 13 and a rear part 23. The razor handle 2 may comprise a spring-loaded pusher 9. The spring-loaded pusher 9 may protrude from the front end 12 of the razor handle 2 and through the interconnecting member 4 to push against a contact surface 10 of the pivotable head 5. The spring-loaded pusher 9 may push against the contact surface 10 along a pushing axis Y′, orthogonal and offset with respect to the transverse axis X, so as to urge the pivotable head 5 in a pivoting direction about transverse axis X thereby maintaining close contact and optimal alignment of the razor blades with respect to the skin during shaving. Although in the illustrated razor 1 the pivotable head 5 is pivotable only around one axis, according to further aspects it may be pivotable around more than one axis. The pivotable head 5 may further comprise a lubricant strip 50 and/or a finned guard bar 51 disposed adjacent to the cutting edges 7 of the razor blades 8. The lubricant strip 50 and/or finned guard bar 51 may be configured to further improve the shaving feel. According to further aspects, the razor blades 8 may be resiliently supported on the pivotable head 5 by being mounted for example on blade springs 52 for a closer shave. Alternatively, however, the razor blades 8 could be directly fixed onto the pivotable head 5, without any such blade springs.

As shown in FIG. 3, the rear part 23 of the razor handle 2 may be configured to function as a release trigger. The central body 13 may be fixed to connector 11, whereas the rear part 23 may be twistable about the longitudinal axis Y relative to the central body 13 and connector 11 while remaining axially attached to both the connector 19 and central body 13. According to further aspects, the central body 13 may comprise latching elements 30 disposed at a rear thereof. The latching elements 30 facilitate latching of the central body 13, about the longitudinal axis Y, onto an undercut circular track 31 formed in the rear part or release trigger 23, as shown in FIG. 4.

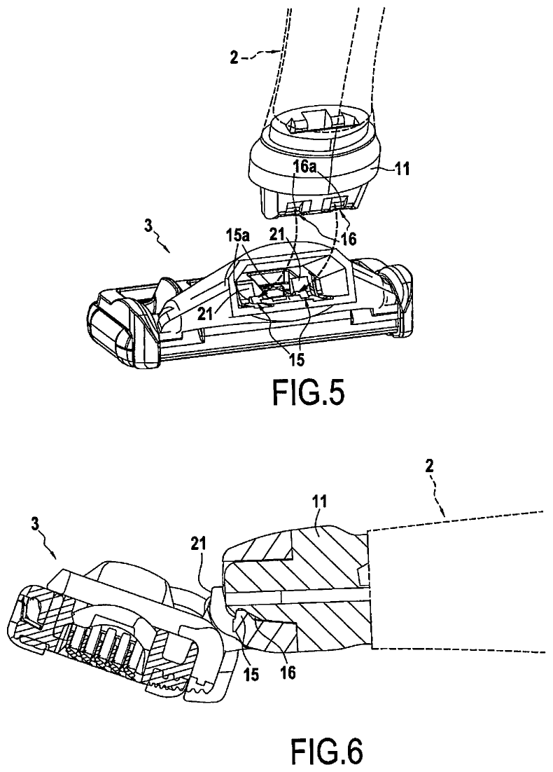

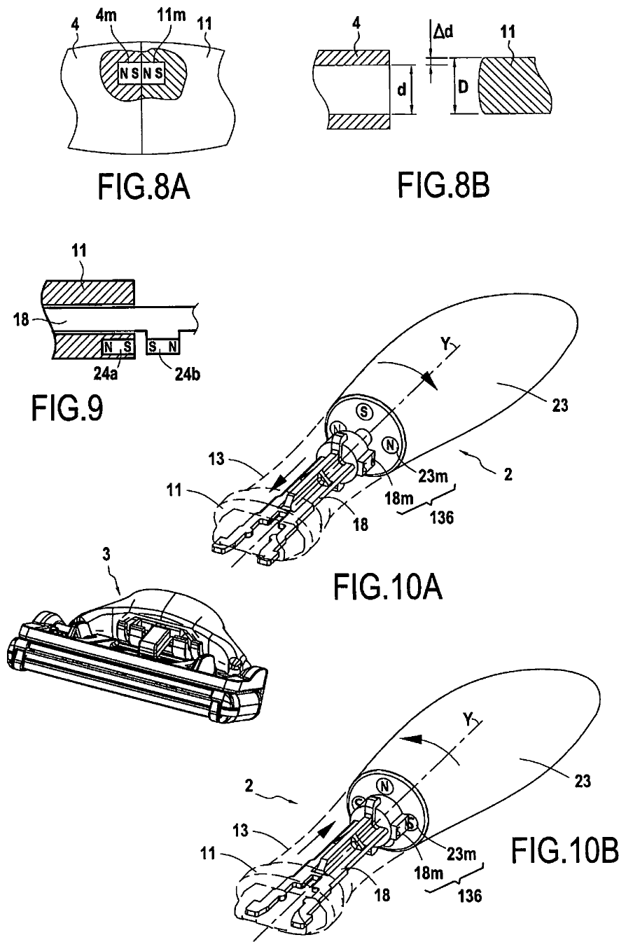

The interconnecting member 4 of the exchangeable razor blade cartridge 3 may be snap-fit onto connector 11 of the actuation assembly 11. As shown in FIGS. 5 and 6, the interconnecting member 4 may comprise protruding lips 15. Protruding lips 15 snap-fit into corresponding undercuts 16 formed in the connector 19, thereby facilitating the snap-fit connection of the connector 11 into the interconnecting member 4. Following the snap-fit connection, latching surfaces 15a on the protruding lips 15 of the interconnecting member 4 engage opposite surfaces 16a of the undercuts 16 of connector 11 to prevent separation of exchangeable razor blade cartridge 3 from razor handle 2. Although in FIGS. 5 and 6 the connection is thus shown as a snap-fit connection, alternatives may instead be considered, such as, for instance, a magnetic connection or a press-fit connection. FIG. 8A schematically illustrates a magnetic connection which may comprise magnets 4m and 11m on, respectively, interconnecting member 4 and connector 11. The magnets 4m and 11m may be oriented with opposite-sign poles facing each other so as to attract the interconnecting member 4 to the connector 11. FIG. 8B schematically illustrates a press-fit connection which may have an interference Δd between a dimension d of interconnecting member 4 and a corresponding dimension D of connector 11, so as to create pressure and thus friction between opposite surfaces of interconnecting member 4 and connector 11 to maintain the connection between interconnecting member 4 and connector 11.

The release mechanism 18 of the actuation assembly 11 may be configured to facilitate release of the exchangeable razor blade cartridge 3 from the razor handle 2. According to further aspects, the release mechanism 18 may be, a fork-shaped ejector, comprising two front prongs 18a extending from and spaced by a central block 18b. The pusher 9 may be positioned between the two front prongs 18a of the release mechanism 18. The pusher spring 20 may be interposed between the pusher 9 and the central body 13.

According to further aspects, the interconnecting member 4 may comprise ears 21 adjacent to the protruding lips 15. Upon assembly, the pusher 9 and the two front prongs 18a of the release mechanism 18 may be received within the connector 11, which may be open at front and rear parts 11a, 11b. The two front prongs 18a may be aligned with respective ears 21 of the interconnecting member 4 of exchangeable razor blade cartridge 3 thereby facilitating disconnection of the connector 11 and razor handle 2 with the interconnecting member 4 of the exchangeable razor blade cartridge 3.

According to further aspects, the central block 18b of the release mechanism 18 may comprise at least one and in particular two pairs of oppositely inclined cam surfaces 35, although higher numbers of pairs can also be considered. The oppositely inclined cam surfaces 35 may be disposed at an end opposite to the two front prongs 18a of the release mechanism 18 and each pair may form one V-shaped concavity. The rear part 23 may comprise a pair of pins forwardly protruding therefrom. Each V-shaped concavity may be configured to receive a respective pin 34 protruding forwardly from the rear part 23. The release mechanism 18 may comprise a shaft 32 protruding from the back thereof. The shaft 32, protruding from the back of release mechanism 18 may be received within a central orifice 33 formed in rear part 23, between the two pins 34 of rear part 23. The oppositely inclined cam surfaces 35 and pins 34 form a cam mechanism 36 for converting rotation of the rear part 23, relative to the connector 11, clockwise and/or counter-clockwise from a central position and about the longitudinal axis Y, into a forward longitudinal and linear motion of the release mechanism 18. The razor handle 2 may further comprise a return mechanism 24, which may for instance be shaped as a spring interposed between the central body 13 and the central block 18b of the release mechanism 18 so as to urge the release mechanism 18 backwards and the rear part 23, through cam mechanism 36, which may be reversible, back into the central position. Although the return force may be provided elastically, as illustrated in FIGS. 3 and 4, in further aspects it may be provided by alternative means, for instance magnetically, as illustrated in FIG. 9. As shown there, instead of springs, the return mechanism 24 may comprise magnets 24a and 24b oriented so that same-sign poles face each other so as to repel each other and interposed between connector 11 and release mechanism 18 so as to provide this magnetic return force.

According to further aspects, the exchangeable razor blade cartridge 3 may be connected to the razor handle 2 by inserting connector 11 into interconnecting member 4 as shown in FIG. 4, until protruding lips 15 of interconnecting member 4 snap into undercuts 16 of connector 11, as shown in FIG. 5. Engagement of latching surfaces 15a on the protruding lips 15 of the interconnecting member 4 against opposite surfaces 16a of the undercuts 16 of connector 11 then prevents axial separation of the connector 11 from interconnecting member 4 in the direction of longitudinal axis Y. Cooperating non-round cross-sectional shapes of the connector 11 and interconnecting member 4 may also prevent relative rotation of the connector 11 and interconnecting member 4 once joined by this snap-fit connection.

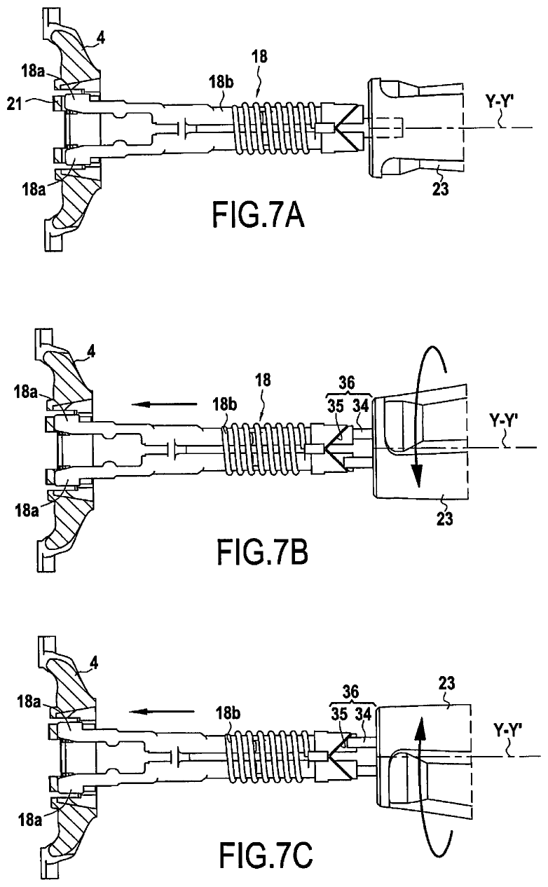

To then trigger the release of exchangeable razor blade cartridge 3 from razor handle 2, rear part 23 may be twisted either way, clockwise and/or counter-clockwise from the starting position as shown on FIG. 7A, about the longitudinal axis Y, relative to central body 13 and connector 11, pushing forward the release mechanism 18 through the cam mechanism converting the twisting motion of rear part 23 into a forward motion of release mechanism 18. As such, pins 34 of the rear part 23 may abut against respective cam surfaces 35 at the rear of central block 18b of release mechanism 18. Engagement of the pins 34 with the cam surfaces 35 may actuate the longitudinal and linear motion of the release mechanism 18. As the release mechanism 18 moves forward against return mechanism 24, the two front prongs 18a may push against ears 21 of the interconnecting member 4, as shown on FIGS. 7B and 7C. With the interconnecting member 4 still retained by the engagement of latching surfaces 15a on the protruding lips 15 of the interconnecting member 4 against opposite surfaces 16a of the undercuts 16 of connector 11, a force may be exerted by the front prongs 18a on ears 21 of the interconnecting member 4. The force imparted on the ears 21 will induce a bending stress in the interconnecting member 4 that will deflect the latching surfaces 15a until they snap out of engagement with the opposite surfaces 16a on the undercuts 16 of connector 11, thus releasing the interconnecting member 4 from connector 11. A further push of the two front prongs 18a against ears 21 may impart a force upon the pusher-spring 20 and pusher 9 to separate the exchangeable razor blade cartridge 3 from razor handle 2. After the user stops twisting the rear part 23 with respect to the central part 13 and connector 11, return mechanism 24 may push back release mechanism 18 so as to return release mechanism 18 towards the starting position. This returning movement of release mechanism 18 may in turn, through cam mechanism 36, which may be reversible, also return rear part 23 towards the starting position.

Further aspects may comprise that, apart from the razor blades 8 and springs, which are usually metallic, a majority of the parts of the razor 1 may be produced from organic polymeric material. Additional aspects may comprise injection molding techniques such as co-injection. Co-injection techniques may be used to produce parts with multiple colors and/or textures. For example, the razor handle 2 may comprise an elastomer for providing a good grip, co-injected on a more rigid thermoplastic polymer providing structural integrity. However, alternatively or complementarily to organic polymeric materials, other materials, such as for instance metal, glass or wood, and in particular moldable materials, may be used. Higher-density materials may for instance be used within the razor handle 2 in order to locate the center of gravity of the razor 1 at an ergonomically optimal location.

Furthermore, it is also possible to replace the cam mechanism 36 with alternative means, such as for example a magnetic mechanism, to convert the rotation of the release trigger into a longitudinal movement of the release mechanism. Such an alternative magnetic mechanism 136, replacing both the cam mechanism 36 and the return mechanism 24, is schematically illustrated in FIGS. 10A and 10B. As shown in this schematic drawing, release mechanism 18 may be glidingly held within the razor handle 2, so as to move only along longitudinal axis Y with respect to the connector 11 at the front of the razor handle 2, as in the previous aspects, and further comprise, instead of inclined cam surfaces, at least one magnet 18m, laterally offset and parallel with respect to longitudinal axis Y. Release mechanism 18 may further be backstopped within the razor handle 2, to limit its forward gliding movement along longitudinal axis Y. Opposite to this magnet 18m, the rear part 23 of the razor handle 2 may, as in the previous aspects, be configured as a release trigger rotatable about longitudinal axis Y with respect to the connector 11. The rear part 23, as a release trigger, may further comprise a plurality of magnets 23m arranged with alternating polarities in a circumference around longitudinal axis Y, adjacently and oppositely to magnet 18m of the release mechanism 18.

In operation, as the user rotates the release trigger, that is, rear part 23, around the longitudinal axis Y, the magnet 18m on release mechanism 18 will alternatively repel and be attracted to magnets 23m on the rear part 23. When this rotation opposes a rear pole of magnet 18m to a front pole, of a magnet 23m, with the same sign, the magnetic repulsion force between the opposing magnets may actuate the release mechanism 18, moving it forward to release the exchangeable blade cartridge 3 from the connector 11 at the front of the razor handle 2, as shown in FIG. 10A. If the user stops twisting the release trigger, that is, rear part 23, with respect to the connector 11, magnetic repulsion between same-sign magnetic poles on magnets 18m and 23m and magnetic attraction between opposite-sign magnetic poles on magnets 18m and 23m may automatically return both the release mechanism 18 and rear part 23 towards a starting position, as shown in FIG. 10B, in which release mechanism 18 is held back by attraction of the rear pole of magnet 18m to an opposite-sign pole of one of the magnets 23m on rear part 23.

Those skilled in the art will recognize that the present disclosure may be manifested in a variety of forms other than the specific aspects described and contemplated herein. Accordingly, departure in form and detail may be made without departing from the scope of the present disclosure as described in the appended claims.

1.-11. (canceled)

12. A razor handle comprising:
a body extending in a longitudinal direction between a front end and a rear part;
a connector for connecting an exchangeable razor blade cartridge to the razor handle;
a release mechanism for releasing the exchangeable razor blade cartridge from the razor handle; and
a release trigger, the release trigger being rotatable about a longitudinal axis of the razor handle, relative to the connector, to actuate the release mechanism.

13. The razor handle according to claim 12, wherein the release trigger being the rear part of the razor handle and the connector being located at the front end of the razor handle.

14. The razor handle according to claim 12, further including a cam mechanism for converting a rotation of the release trigger about the longitudinal axis, relative to the connector, into a motion along the longitudinal axis to actuate the release mechanism.

15. The razor handle according to claim 14, wherein the cam mechanism includes first and second cam surfaces inclined in opposite directions, the first and second cam surfaces being operable to convert opposite rotational movements of the release trigger into longitudinal movements.

16. The razor handle according to claim 14, wherein the release mechanism is configured to deflect in response to rotation of the release trigger.

17. The razor handle according to claim 16, further including a spring-loaded pusher disposed at the front end of the body.

18. The razor handle according to claim 17, wherein the release mechanism is a fork-shaped ejector having two front prongs, and the spring-loaded pusher is located between the two front prongs.

19. A razor comprising:
a razor handle according to claim 12, and
an exchangeable razor blade cartridge connected to the razor handle.

20. The razor according to claim 19, wherein the exchangeable razor blade cartridge includes a head, at least one razor blade, and an interconnecting member for engaging the connector of the razor handle; the head being pivotable about an axis parallel to the at least one razor blade.

21. The razor according to claim 19, wherein the exchangeable razor blade cartridge is snap-fitted to the razor handle.

22. A method for releasing an exchangeable razor blade cartridge from a razor handle, comprising a step of:
rotating a release trigger of the razor handle about a longitudinal axis of the razor handle, and
actuating a release mechanism to release the exchangeable razor blade cartridge from the razor handle.
